(19) United States
(12) Patent Application Publication
(10) Pub. No.: US 2007/0023454 A1
(43) Pub. Date: Feb. 1, 2007

(54) Antibacterial foam generator

(76) Inventor: Heiner Ophardt, Vineland (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 11/471,557

(22) Filed: Jun. 21, 2006

(30) Foreign Application Priority Data
Jul. 28, 2005 (CA) 2513181

(51) Int. Cl. B67D 5/58

(52) U.S. Cl. 222/190; 222/181.1

(57) ABSTRACT

A dispenser for dispensing fluid which passes fluid through a porous member carrying, comprising or coated with a germicide which, by contact with fluid passing therethrough, assists in at least partially disinfecting the fluid.

### SCOPE OF THE INVENTION

This invention relates to fluid dispensers and, more particularly, to at least partially disinfecting fluid dispensed from or drawn back into a dispenser.

### BACKGROUND OF THE INVENTION

Foaming dispensers are known to dispense liquid and air, preferably simultaneously, outwardly through a foam generator typically comprising a porous member to produce foam. With some foaming dispensers, such as disclosed in U.S. Pat. No. 6,601,736 to Ophardt, not only is liquid and air forced outwardly through the foam generator but, subsequently, air, foam and/or liquid is drawn back through the foam generator. In some dispensers taught by U.S. Pat. No. 6,601,736 which use a non-collapsing bottle without a separate return port other than through the foam generator, substantially all the air required to eliminate the development of a vacuum in the bottle enter the bottle after passing through the foam generator. In addition, with many other pumping arrangements, particularly those to produce foam, substantial volumes of air may be drawn into a pump mechanism and, subsequently, ejected outwardly therefrom. Some known soap dispensers after dispensing in a manner which may or may not produce foam, draw back some fluid dispensed as, for example, to reduce dripping of the fluid from an outlet and in such draw back of fluid, may draw back at least some air with the fluid dispensed. The present inventor has appreciated that a risk exists that biological contaminants which may become drawn back into a dispensing system may grow and contaminate the dispenser as, for example, in the outlet, in a foam generating member, in the pump mechanism, in the fluid container or elsewhere.

A disadvantage of many dispensers is that fluid may drip from a dispensing outlet. Additionally, such fluid as remains at or near the dispensing outlet is at risk that biological contaminants may be present on or at the dispensing outlet or in fluid which has not dripped therfrom.

### SUMMARY OF THE INVENTION

To at least partially overcome these disadvantages of previously known devices, the present invention provides a dispenser for dispensing fluid which passes fluid through a porous member carrying, comprising or coated with a germicide which, by contact with fluid passing therethrough, assists in at least partially disinfecting the fluid.

An object of the present invention is to provide a dispenser to assist in at least partially disinfecting fluid passed therethrough.

Another object is to provide a foam generating porous member including a germicide which assists in disinfecting fluid passing therethrough.

Another object is to provide a dispenser which dispenses fluid outwardly therethrough and draws fluid back inwardly in which fluid drawn back inwardly is moved in a manner to come into contact with a germicide.

Another object of the present invention is to provide an improved dispenser which avoids dripping.

In one aspect, the present invention provides a dispenser for dispensing foam which passes liquid and air simultaneously outwardly through a foam generating porous member in which the porous member has a surface carrying, comprising or coated with a germicide which by contact with the liquid, air and foam therein or passing therethrough at least partially disinfects the liquid, air or foam. Preferably, after dispensing foam through the porous member, the dispenser draws back inwardly through the porous member one or more of air and a portion of the dispensed liquid and foam, with the air, liquid and foam drawn back contacting surfaces of the porous member coated with the germicide to at least partially disinfect the air, liquid and foam drawn back to assist in killing microorganisms therein or reducing growth of microorganisms in the dispenser.

In another aspect, the present invention provides a dispenser for dispensing fluid which passes fluid outwardly through a porous member and which, after dispensing fluid outwardly through the porous member, draws back inwardly through the porous member one or more of air and a portion of the dispensed fluid. The porous member preferably has a surface carrying, comprising or coating with the germicide which by contact with the fluid and air therein passing outwardly or inwardly therethrough at least partially disinfects the fluid or air drawn back to assist in destroying microorganisms in the fluid or air and to reduce growth of microorganisms in the dispenser.

In another aspect, the present invention provides a porous member at the dispensing outlet of a dispenser for dispensing fluid and/or foam to assist in reducing dripping of fluid from the outlet after dispensing is stopped. Preferably, the process member provides germicidal properties to resist microorganism growth or kill the same in the porous member and fluid contained therein. The porous member may be advantageously provided whether or not in operation of the dispenser there may be draw backs though the porous member.

The porous material may comprise any material through which fluid may flow and when it is to have germicidal properties will provide a surface comprising the germicide. One preferred form of the porous material comprises plastic material coated with the germicide. The plastic material may preferably comprise a porous form of plastic material, for example, open celled foamed plastic. Preferred plastic may be selected from the group consisting of polyurethane, polypropylene, polyethylene, polystyrene, polyolefin and copolymers thereof. Rather than comprise a porous foam, the porous material may comprise a screen of strands comprising, for example, plastic or metal. For example, the screen may comprise a screen of plastic, metal or other materials coated with a germicide. The plastic material may be in the form not only of a porous foam but also of other forms such as, for example, a screen or mesh, a batting of bonded fibres and a porous body formed as by sintering.

The germicide is a compound which assists resisting growth of biological contaminants as preferably by killing biological contaminants. The biological contaminants are typically to be considered microorganisms such as bacterial and viruses which may be present in the fluids, liquid, air and foam as, for example, may come to contaminate the same by being air borne and by being transferred by contact with contaminated elements such as a person's hands who may be using a dispenser. The germicide preferably comprises a bactericide which has antibacterial properties. Preferred germicides and bactericides comprise metal ions preferably selected from one or more of the group consisting of silver, copper, mercury, zinc, titanium, nickel and cobalt. Preferably, the metal ions are coated on the plastic material, preferably as small particles of the metal, preferably as nanoparticles of the metal. A preferred metal is silver.

A preferred porous member with germicidal properties comprises polyurethane foam coated with silver nanoparticles.

The silver or other metal ions may be coated on the plastic material by soaking the plastic material, preferably foamed polyurethane, in a solution prepared by reacting an aqueous solution of silver nitrate with a sodium citrate solution.

The porous member may also comprise a screen, for example, a screen of plastic material coated with silver nanoparticles or a screen of metal coated with silver or a screen formed from strands of silver metal.

The germicide preferably is adapted to disinfect fluid coming into contact therewith preferably towards the inactivation of pathogenic microorganisms. Since the germicide is to preferably maintain useful germicidal properties for extended periods of time and, preferably, acts by contact with the fluid, providing the germicide on the surface of porous plastic materials, preferably as nanoparticles coated on the plastic materials, can provide a large surface to volume ratio which enhances increased contact with the fluid.

### BRIEF DESCRIPTION OF THE DRAWINGS

Further aspects and advantages of the present invention will appear from the following description taken together with the accompanying drawings in which:

FIG. 1 is a partially cut away side view of a fluid dispenser with a reservoir and pump assembly in accordance with the present invention;

FIG. 2 is a cross-sectional side view of a pump assembly of a type adapted for use with a dispenser of the type shown in FIG. 1;

FIG. 3 is an exploded pictorial view of the foam generator assembly of the pump assembly shown in FIG. 2;

FIG. 4 is a cross-sectional side view of a pump assembly for dispensing foam from a collapsible container as disclosed in U.S. Pat. No. 6,409,050, however, modified to have a foam generator with germicidal properties in accordance with the present invention;

FIGS. 5 and 6 are cross-sectional side views of a non-foaming liquid pump in accordance with a further aspect of this invention showing a piston in an extended position in FIG. 5 and a retracted position in FIG. 6.

### DETAILED DESCRIPTION OF THE DRAWINGS

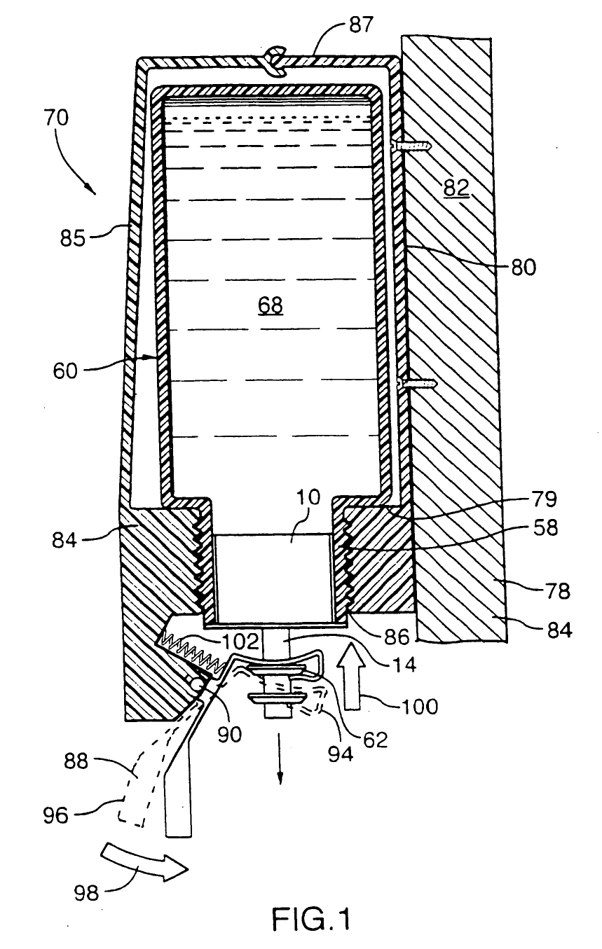

Reference is made to FIG. 1 which schematically shows a liquid soap dispenser generally indicated 70 utilizing a pump assembly 10 coupled to the neck 58 of a sealed collapsible container or reservoir 60 containing liquid hand soap 68 to be dispensed. Dispenser 70 has a housing generally indicated 78 to receive and support the pump assembly 10 and the reservoir 60. Housing 78 is shown with a back plate 80 for mounting the housing, for example, to a building wall 82. A bottom support plate extends forwardly from the back plate to support and receive the reservoir 60 and pump assembly 10. The bottom support plate 84 has a circular opening 86 therethrough. The reservoir 60 sits supported on the shoulder 79 of the support plate 84 with the neck 58 of the reservoir extending through the opening 86 and secured in the opening as by a friction fit, clamping and the like. A cover member 58 is hinged to an upper forward extension 87 of the back plate so as to permit replacement of reservoir 60 and its pump assembly 10. Support plate 84 carries at a forward end thereof an actuating lever 88 journalled for pivoting about a horizontal axis at 90. The upper end of the lever carries a hook 94 to engage engagement discs 62 and couple lever 88 to piston 14, such that movement of the lower handle end 96 of lever 88 from the dashed line position to the solid line position in the direction indicated by arrow 98 slides piston 14 inwardly in a retracting pumping stroke as indicated by arrow 90. On release of the lower handle end 96, spring 102 biases the upper portion of the lever downwardly so that the lever draws piston 14 outwardly to a fully withdrawn position as seen in dashed lines in FIG. 1. Lever 88 and its inner hook 94 are adapted to permit manual coupling and uncoupling of the hook 94 as is necessary to remove and replace reservoir 60 and pump assembly 10. Other mechanisms for moving the piston can be provided including mechanized and motorized mechanisms.

In use of the dispenser 70, once exhausted, the empty collapsed reservoir 60 together with the attached pump are removed and a new reservoir 60 and attached pump 10 may be inserted into the housing. Preferably, the removed reservoir and its attached pump 10 are made entirely out of recyclable plastic material which can easily be recycled without the need for disassembly prior to cutting and shredding.

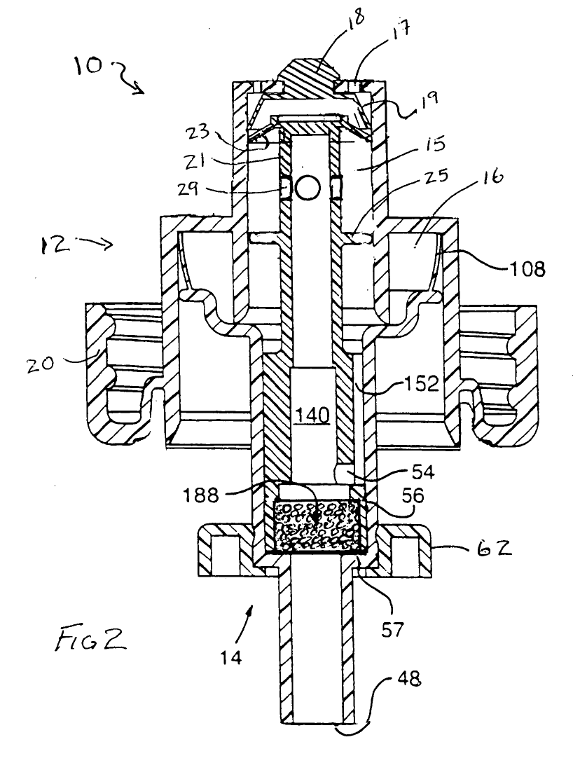

Reference is made to FIG. 2 which illustrates a pump assembly 10 comprising two principal elements, a piston chamber-forming body 12 and a piston 14. The piston chamber-forming body 12 is cylindrical and coaxially disposed about a central axis. The piston chamber-forming body 12 forms a central cylindrical liquid chamber 15 and a cylindrical outer air chamber 16 thereabout. The liquid chamber 15 has in its inner end liquid inlet openings 17 for passage of liquid from the reservoir into the liquid chamber. A one-way valve member 18 of resilient material is secured in the inner end of the liquid chamber 15 having a radially outwardly biased resilient annular flange 19 which engages the side wall of the liquid chamber 15 and prevents fluid flow inwardly therepast yet permits fluid flow outwardly therepast.

The piston chamber-forming body 12 has an outer threaded flange 20 adapted to be secured in a sealed relation on a threaded end of a reservoir.

The piston 14 has a central stem 21 with a central passageway 140 therethrough enclosed at an inner end. Three disc members extend radially outwardly from the stem. At the inner end of the stem, there is an inner disc 23 which extends radially outwardly. The inner disc 23 has an annular resilient flange which engages the wall of the liquid chamber 15 in a manner to prevent fluid flow inwardly therepast but yet permits resilient deflection to permit flow outwardly therepast. An intermediate disc 25 is spaced outwardly from the inner disc 23 and has an annular flange which engages the wall of the liquid chamber 15 in a sealed manner so as to at least prevent fluid flow outwardly therepast but also preferably prevents fluid flow inwardly therepast.

The outer disc 108 is disposed outwardly from the intermediate disc 25 and has a radially outwardly extending resilient flange to engage the wall of the air chamber 16 preventing fluid flow outwardly therepast and also preventing air flow inwardly therepast.

Liquid inlet openings 29 are provided between the inner disc 23 and the intermediate disc 25 through the wall of the stem 21 into the central passageway 140. The arrangement of the liquid chamber 15 and the stem 21 including the inner disc 23 and intermediate disc 25 in the liquid chamber 15 form a liquid pump which operates substantially identically to the pump disclosed in FIG. 9 of U.S. Pat. No. 5,676,277 to Ophardt which is incorporated herein by reference. On sliding of the piston 14 outwardly, fluid in the reservoir is drawn outwardly past the one-way valve member 18 into the liquid chamber 15 between the one-way valve member 18 and the inner disc 23. On movement of the piston 14 inwardly, fluid between the one-way valve member 18 and the inner disc 23 is pressurized and forced past the inner disc 23 into the space between the inner disc 23 and the intermediate disc 25 and, hence, through the liquid inlet openings 29 and into the passageway 140.

The stem 21 also carries an air inlet way to provide communication between the central passageway 22 and the air chamber 16. The air inlet way is shown as an axially extending channel 152 open at its inner end into the air chamber 16 and ending at a radially inwardly extending port 54 opening into the passageway 140.

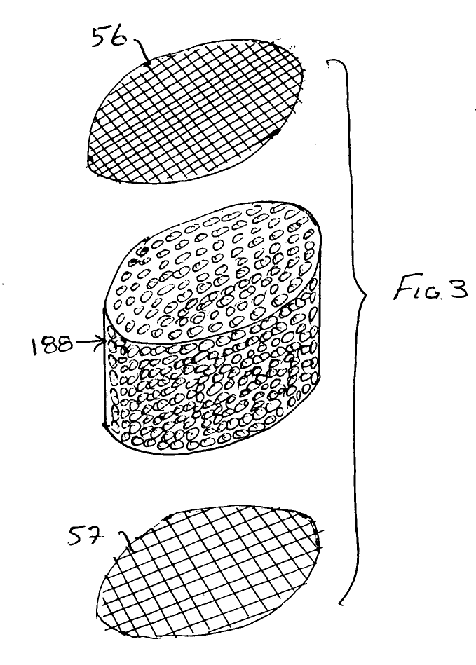

In the passageway 140, outwardly of the port 54 and the liquid inlet openings 29, there is provided a foam generating assembly which is disposed across the passageway. The foam generating assembly is best illustrated in FIG. 3 as comprising a foam plastic member 188 disposed between an inner screen 56 and outer screen 57. On movement of the piston 14 inwardly, liquid from the liquid chamber 15 and air from the air chamber 16 are simultaneously forced through the foam generating assembly and, hence, out the outlet 48. In a return stroke on moving the piston 14 outwardly, atmospheric air as well as foam and/or liquid in the outlet tube 22 downstream from the foam generating assembly are drawn inwardly through the foam generating assembly.

Preferably, each of the screens 56 and 57 and the foam plastic plug 188 have surfaces which carry, comprise or are coated with the germicide which will at least partially disinfect the liquid, foam or air passing inwardly or outwardly therethrough which come into contact with their surfaces. Preferably, the foam plastic plug is a polyurethane foam coated with silver nanoparticles which provide an antibacterial effect. Each of the screens may comprise a screen or mesh formed of strands of silver material or, more preferably, a screen of metal or plastic coated with silver ions. Each screen may comprise a batting of bonded fibres.

While the preferred embodiment illustrates a foam generating assembly including two screens and a plug, it is to be appreciated that only one or more of these three elements need be provided to assist in providing a germicide effect, preferably a bactericide effect.

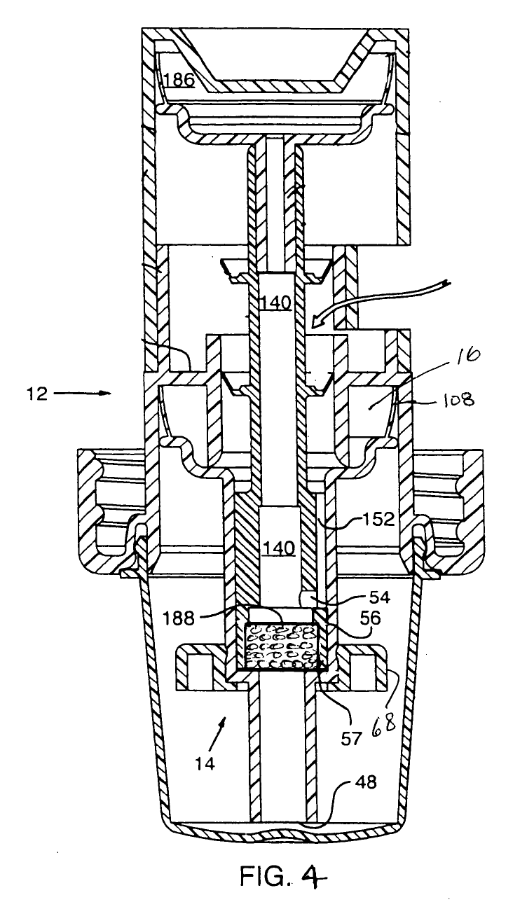

Reference is made to FIG. 4 which illustrates a pump assembly as disclosed in FIG. 17 of U.S. Pat. No. 6,409,050 to Ophardt, however, modified merely to include a foam generator assembly with a foam plastic member 188 in accordance with the present invention in addition to screens 56 and 57. Similar reference numerals are used in FIG. 4 to refer to similar elements shown in FIG. 7. The pump assembly of FIG. 4 has a piston 14 reciprocally slidable in a piston chamber-forming body. The pump of FIG. 4 has two air chambers 16 and 186 with air to be drawn into each of these air chambers through the foam generating assembly comprising a combination of elements 188, 56 and 57. Additionally, the pump of FIG. 4 is adapted for use with a non-collapsible container. To avoid a vacuum being developed in the non-collapsible container, air is permitted to pass through the foam generating assembly into the air chamber 16 and, subsequently, in cycling of the piston 14 from the air chamber into the container to prevent a vacuum from developing in the container. In the embodiment of FIG. 4, air which passes through the foam generating assembly not only enters the air chambers 16 and 186 but also enters the container as the fluid is dispensed.

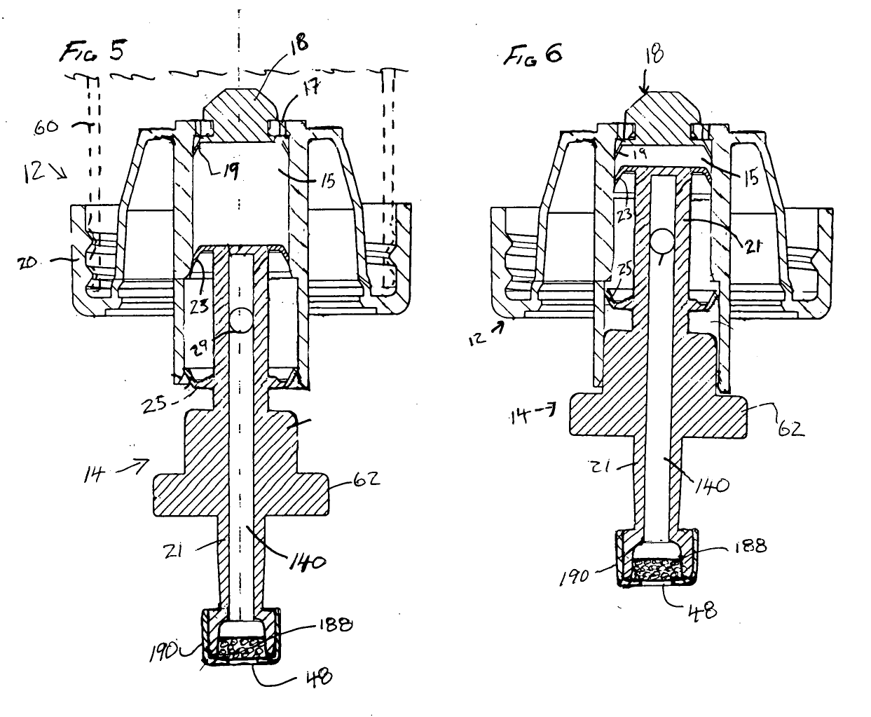

Reference is made to FIGS. 5 and 6 which show cross-sectional side views of another pump assembly in accordance with the present invention. In FIGS. 5 and 6, similar reference numerals are used to refer to similar elements shown in FIG. 2. The pump assembly of FIGS. 5 and 6 provides merely a liquid pump which is very similar in its construction to the liquid pump of the pump assembly of FIG. 2, however, with the exception that the interior wall of the liquid chamber 15 is stepped having a smaller diameter in the portions to engage the inner disc 23 and a larger diameter portion to engage the intermediate disc 25. As a result, in a withdrawal stroke in moving from the position of FIG. 6 to the position of FIG. 5, liquid which was previously dispensed into the central passage 140, is drawn back through the liquid opening 29 into the liquid chamber 15 between the inner disc 23 and the intermediate disc 25. Such draw back is advantageous, for example, to assist in reducing dripping of product after dispensing has stopped. The volume of draw back can be controlled as desired. A porous plug 188 is shown as provided across the outlet 48 of the piston 14 preferably comprising a plug of foamed polyurethane held in place by a snap-on cap 190. Liquid which is drawn back with or without air depending on the volume of the draw back which is drawn back into the passageway 140 is drawn back through the porous plug 188 which preferably has germicidal properties. Draw back may preferably be sufficient merely to draw back fluid on the outer face of the porous plug back into the porous plug 188.

The embodiment of FIGS. 5 and 6 illustrate a draw back pump with a foam plug at its outlet end. This invention, however, includes a modified form of FIGS. 5 and 6 in which there is no draw back and by reason of making the liquid chamber of a constant diameter throughout its length, with both the inner disc 23 and intermediate disc 25 of the same diameter so as to have the piston act as the liquid pump illustrated in FIG. 2. In this modified form of FIGS. 5 and 6, the porous plug 188 and/or screens such as 56 and 57 will be provided at the outlet 48. The porous plug 188 and/or screens assist in reducing dripping, at the least, by reason of increased surface area for contact and therefore retension of fluid in the plug 188 and passageway 140 to resist dripping due to gravity. Advantageously, but not necessarily, the porous plug 188 or screens 56 and 57 may have germicidal properties.

The preferred embodiments of the invention have been illustrated with respect to pump assemblies adapted for dispensing liquid from a reservoir typically illustrated for dispensing with the reservoir disposed above the pump assembly. This is not necessary. Other similar pumps may be used to pump from reservoirs located below the pump. Various other foaming and non-foaming pumps and pumps with and without draw back can be adapted to receive a porous member for fluid passage therethrough. The porous member may be located near or at the end of an outlet as to reduce dripping. The porous outlet may be provided to have germicidal and antibacterial properties to assist in reducing biological growth in the dispenser and its components.

In the case where the porous member is used at or near the outlet of a pump which does not draw fluid back through the porous member, then providing the porous member to have germicidal properties is advantageous such that fluid which may be retained in the porous member may at least be provided with a reduced tendency for growth or maintenance of microorganisms.

While the invention has been described with reference to preferred embodiments, many modifications and variations will now occur to persons skilled in the art. For a definition of the invention, reference is made to the following claims.

1. A dispenser for dispensing foam which passes liquid and air simultaneously outwardly through a foam generating porous member, the porous member having a surface carrying, comprising or coated with a germicide which by contact with the liquid, air and foam therein or passing therethrough at least partially disinfecting the liquid, air and foam.

2. A dispenser as claimed in claim 1 which after dispensing foam through the porous member, draws back inwardly through the porous member one or more of air and a portion of the dispensed liquid and foam, with air, liquid and foam drawn back contacting the surface of the porous member coated with the germicide at least partially disinfecting the air, liquid and foam drawn back to assist in killing microorganisms in the dispenser or reducing growth of microorganisms in the dispenser.

3. A dispenser for dispensing fluid which passes fluid outwardly through a porous member and which after dispensing fluid outwardly through the porous member, draws back inwardly through the porous member one or more of air and a portion of the dispensed fluid, the porous member having a surface carrying, comprising or coated with a germicide which by contact with the fluid and air therein or passing outwardly or inwardly therethrough at least partially disinfecting the fluid or air drawn back to assist in destroying microorganisms in the dispenser and reducing growth of microorganisms in the dispenser.

4. A dispenser as claimed in claim 2 in which the porous member comprises a plastic material coated with the germicide.

5. A dispenser as claimed in claim 4 wherein the germicide is a bactericide.

6. A dispenser as claimed in claim 5 in which the bactericide comprises metal ions.

7. A dispenser as claimed in claim 6 in which the metal ions are selected from one or more of the group consisting of silver, copper, mercury, zinc, titanium, nickel, and cobalt.

8. A dispenser as claimed in claim 7 in which the metal ions are coated on the plastic material.

9. A dispenser as claimed in claim 8 in which the metal ions are coated on the plastic as nanoparticles of the metal.

10. A dispenser as claimed in claim 8 in which the plastic material is a porous foam.

11. A dispenser as claimed in claim 10 in which the plastic is selected from the group consisting of polyurethane, polypropylene, polyethylene, polystyrene, polyolefin and copolymers thereof.

12. A dispenser as claimed in claim 11 in which the germicide comprises silver.

13. A dispenser as claimed in claim 12 in which the plastic material is in a form of selected from a porous foam, a screen, a batting of bonded fibers, and a porous sintered body.

14. A dispenser as claimed in claim 12 in which the plastic material is a porous foamed polyurethane.

15. A dispenser as claimed in claim 14 in which the silver is coated on the plastic material as silver nanoparticles.

16. A dispenser as claimed in claim 15 in which the silver is coated on the plastic material by soaking the foamed polyurethane in a solution prepared by reacting an aqueous solution of silver nitrate with a sodium citrate solution.

17. A dispenser as claimed in claim 2 in which the porous member comprises a screen of strands comprising, carrying, coated with or consisting of metal.

18. A dispenser as claimed in claim 17 in which the metal is from one or more of the group consisting of silver, copper, mercury, zinc, titanium, nickel, cobalt, and mixtures thereof.

19. A dispenser as claimed in claim 18 in which the metal is silver.

20. A dispenser as claimed in claim 17 in which the screen is selected from a screen of plastic coated with silver and a screen of strands of silver metal.

21. A fluid dispenser for dispensing fluid from an outlet, a porous member of foamed plastic disposed across the outlet to assist in reducing dripping of fluid from the outlet under gravity after dispensing has stopped.

22. A dispenser as claimed in claim 21 wherein the porous member having a surface carrying, comprising or coated with a germicide which by contact with the liquid, air and foam therein or passing therethrough at least partially disinfecting the liquid, air and foam.
